(19) United States
(12) Patent Application Publication
(10) Pub. No.: US 2018/0330753 A1
(43) Pub. Date: Nov. 15, 2018

(54) KIT-OF-PARTS CONTAINING A SEALING LAYER AND A PHOTOPOLYMER

(71) Applicant: Covestro Deutschland AG, Leverkusen (DE)

(72) Inventors: Thomas FÄCKE, Leverkusen (DE); Serguei KOSTROMINE, Swisttal-Buschhoven (DE); Enrico ORSELLI, Köln (DE); Ute FLEMM, Solingen (DE)

(21) Appl. No.: 15/774,167

(22) PCT Filed: Nov. 9, 2016
(86) PCT No.: PCT/EP2016/077139

§ 371 Date: May 7, 2018

(30) Foreign Application Priority Data
Nov. 9, 2015 (EP) 15193765.3

(51) Int. Cl. G11B 7/24044; G11B 7/245; G11B 7/254

(52) U.S. Cl. CPC G11B 7/24044; G11B 7/254; G11B 7/245

(57) ABSTRACT

The invention relates to a kit-of-parts comprising at least one sealing layer C and a photopolymer B, a process for producing an at least partly interconnected layered setup formed of at least 2 layers, the use of the at least one sealing film C to protect the photopolymer B, the use of the kit-of-parts for the process referred to, a sealed holographic medium comprising the photopolymer and optical displays and security document comprising the sealed holographic medium.

The invention relates to a kit-of-parts comprising at least one sealing layer C and a photopolymer B, a process for producing an at least partly interconnected layered setup formed of at least 2 layers, the use of the at least one sealing film C to protect the photopolymer B, the use of the kit-of-parts for the process referred to, a sealed holographic medium comprising the photopolymer and optical displays and security document comprising the sealed holographic medium.

Photopolymer layers for manufacturing holographic media are in principle known from WO 2011/054797 and WO 2011/067057. What is advantageous about these holographic media is their high level of light diffraction efficiency and that post holographic exposure they require no post-processing steps such as, for example, chemical or thermal steps of development.

DE 699 37 920 T2 relates that the colour of holographic types of photopolymer layers can change as a result of substances swelling from adjacent layers such as adhesive layers into the photopolymer layer or bleeding therefrom into the adjacent layer. If either phenomenon occurs, a volume expansion or a volume contraction may take place in the photopolymer layer. This in turn leads to the hologram undergoing a colour shift towards respectively long and short wavelengths. Undesired visual changes in colour are caused by this in the case of multi-coloured holograms in particular.

DE 699 37 920 T2 addresses the problem of avoiding volume changes and the attendant colour changes by adding from the start sufficient amounts of the swelling or bleeding substances to the adjacent layers and/or the photopolymer layer. This method is burdensome, however. Moreover, some adaptation will be needed according to which material is to be used for the adjacent layer. Lastly, the choice of substance added must not destroy the photopolymer layer.

EP 2613318 B1 relates that protective layers are coatable on an exposed photopolymer layer by suitably selecting the components. These protective layers are obtainable by reacting at least a by radiation curing resin I), an isocyanate-functional resin II) and a photoinitiator system III). The protective layers described in EP 2613318 B1 meet the requirements of a suitable protective layer because, after coating, they provide a layered setup that comprises a protective layer and an exposed photopolymer layer and is firmly connectable to a very wide variety of adjacent layers such as, for example, adhesive layers without incurring any volume changes of the photopolymer layer and any attendant colour changes of the hologram.

EP 2804763 A1 teaches that suitability also extends to protective coating layers consisting of a at least by radiation curing resin I), a polyfunctional by radiation curing resin II) and a photoinitiator system III), provided that the by radiation curing resin I) contains ≤5 wt % of compounds having a weight-average molecular weight <500 and ≥75 wt % of compounds having a weight-average molecular weight >1000, the polyfunctional by radiation curing resin II) comprises or consists of at least one acrylate having two by radiation curing groups at least, and the mixture contains not less than 55 wt % of the by radiation curing resin I) and not more than 35 wt % of the polyfunctional by radiation curing resin II).

It is burdensome in industrial practice to build corresponding liquid application systems and dedicate personnel to policing the coating process. Lamination processes are therefore preferred. U.S. Pat. No. 6,447,979B1 thus describes how a protective coating positioned on a supporting layer with release liner (a debonding layer) or an optically variable device (OVD) can be applied to a card base body by means of a thermally activatable layer of adhesive. Thermally activatable layers of this type (“hotmelt adhesive”) are therefore widely used.

The display industry further routinely employs films of optical clear adhesive (“OCA”) to bond glass layers to displays for touch functions for example. Any sealing of volume holograms of the type described above is thereby only possible at the cost of unacceptable changes in frequency.

The problem addressed by the present invention was therefore that of providing, in respect of such exposed photopolymer films as no longer require any post-processing steps post holographic exposure, a solution whereby they are sealable in one simple operation to obtain excellent adherence between the photopolymer and the sealing varnish, without incurring a disadvantageous colour shift of more than 10 nm, preferably of more than 5 nm, or else a line shape change.

The problem was solved by a kit-of-parts comprising at least one sealing layer C and an areal photopolymer B.

The advantage of the kit-of-parts according to the present invention is that, post the exposure of the photopolymer, it provides a simple way to seal an exposed hologram—requiring no costly machines or specially trained personnel—wherein the components B and C are aligned with each other such that they provide good adherence while at the same time ensuring frequency stability/grating stability for the hologram and protection from chemical, physical and mechanical stress. In addition, the sealing layer provides compatibility with further layers as well as an overall improved handleability of the hologram, e.g. protection against dusting by prohibition of residual tackiness or by antistat additization of the sealing layer.

For the purposes of the invention, “areal” is to be understood as meaning an incarnation as a planar area or else as a concavely or convexly vaulted or undulating area. For the purposes of the present invention, the photopolymer B, which contains the hologram, must have a planar, vaulted or undulating area to the extent that lamination with the sealing layer is rendered possible in the hologram region at least.

In one embodiment of the invention, the photopolymer B is in the form of a layer. Preferably, the photopolymer layer B is on a preferably transparent thermoplastic substrate film A or on some other support such as, for example, glass, plastic, metal or wood.

In a further embodiment, the sealing layer C is present on a supporting film D.

In a further embodiment, the sealing layer C is less than 50 μm in thickness. The viscosity of the uncured sealing layer C before curing and drying is preferably in the range from 2000 Pa s to 2 million Pa s, preferably 4000 Pa s to 1.6 million Pa s. The sealing layer C comprises a physically drying resin C1, an acryloyl- or methacryloyl-functional reactive diluent C2 and a photoinitiator C3.

In another embodiment of the invention, the photopolymer B and sealing layer C parts—optionally either one or both supported—of the kit-of-parts are present in the same package. It may be advantageous for them to be packaged separately but combined in one container. It may further be advantageous for processing for photopolymer layer B and sealing layer C to have the same dimensions. Preferably, both the photopolymer layer B and the sealing layer C are in supported form.

The invention likewise provides a process for producing an at least partly interconnected setup formed of at least 2 layers comprising
a) an areal photopolymer B containing a volume hologram, and
b) at least one at least partly actinically cured sealing layer C,
   characterized in that
the photopolymer B containing a volume hologram comprises a crosslinked matrix;
the sealing layer C is less than 50 μm in thickness and has a viscosity of 2000 Pa s to 2 million Pa s, preferably 4000 Pa s to 1.6 million Pa s and comprises a physically drying resin C1, an acryloyl- or methacryloyl-functional reactive diluent C2 and a photoinitiator C3;
and the sealing layer C is laminated onto the photopolymer B and
thereafter cured with actinic radiation.

In one embodiment of the process according to the invention, the photopolymer B is in the form of a layer, preferably on a preferably transparent thermoplastic substrate film A or on some other support such as, for example, glass, plastic, metal or wood.

In a further embodiment of the process, the sealing layer C is present on a supporting film D.

In a further embodiment of the invention, the process of the invention is used to produce an at least partly interconnected setup formed of at least 3 layers comprising an areal photopolymer B containing a volume hologram, at least one at least partly actinically cured sealing layer C and a supporting film D.

The layers therein may be arranged in the order of B, C and D.

In addition, a further sealing layer may also be laminated onto the reverse side of the then both-sidedly areal photopolymer B. The layers may then be arranged in the order of D-C-B-C-D.

In another embodiment of the invention, the process of the invention is used to produce an at least partly interconnected setup formed of at least 4 layers comprising a layer B consisting of a photopolymer, containing a volume hologram and applied atop a substrate film A, at least one at least partly actinically cured sealing layer C and a supporting film D.

The layers in this case may be arranged in the order of A, B, C and D.

In one embodiment of the process, the sealing layer C post lamination onto the photopolymer layer B is at least partly actinically cured within 60 minutes, preferably within 5 minutes, more preferably within less than 60 seconds.

In another embodiment of the process, the layer D or the layers D may be at least partly delaminated post the at least partial curing of sealing layer C.

Materials or material composites of the thermoplastic substrate film A are based on polycarbonate (PC), polyethylene terephthalate (PET), amorphous polyesters, polybutylene terephthalate, polyethylene, polypropylene, cellulose acetate, cellulose hydrate, cellulose nitrate, cycloolefin polymers, polystyrene, hydrogenated polystyrene, polyepoxides, polysulphone, thermoplastic polyurethane (TPU), cellulose triacetate (CTA), polyamide (PA), polymethyl methacrylate (PMMA), polyvinyl chloride, polyvinyl acetate, polyvinyl butyral or polydicyclopentadiene or mixtures thereof. They are more preferably based on PC, PET, PA, PMMA and CTA. Material composites may be coextrudates or film laminates. Preferred material composites are duplex and triplex films constructed according to one of the schemes A/B, A/B/A or A/B/C. PC/PMMA, PC/PA, PC/PET, PET/PC/PET and PC/TPU are particularly preferable. Substrate film A is preferably transparent in the spectral region of 400-800 nm.

Photopolymers B comprise matrix polymers, writing monomers and photoinitiators. Useful matrix polymers include amorphous thermoplastics such as, for example, polyacrylates, polymethyl methacrylates or copolymers of methyl methacrylate, methacrylic acid or other alkyl acrylates and alkyl methacrylates and also acrylic acid, e.g. polybutyl acrylate, further polyvinyl acetate and polyvinyl butyrate its partially hydrolyed derivatives such as polyvinyl alcohols and also copolymers with ethylene and/or further (meth)acrylates, gelatin, cellulose esters and cellulose ethers such as methylcellulose, cellulose acetobutyrate, silicones, e.g. polydimethylsilicone, polyurethanes, polybutadienes and polyisoprenes, and also polyethylene oxides, epoxy resins, in particular aliphatic epoxy resins, polyamides, polycarbonates and also the systems used in U.S. Pat. No. 4,994,347A and cited therein.

However, it is particularly preferable for the matrix polymers to be polyurethanes.

It is also particularly preferable for the matrix polymers to be in a crosslinked state. It is especially preferable in this connection for the matrix polymers to be in a three-dimensionally crosslinked state.

Epoxy resins are self-crosslinkable cationically. It is further also possible to use acids, anhydrides, amines, hydroxyalkylamides and also thiols as crosslinkers.

Silicones are crosslinkable not only as one-component systems through condensation in the presence of water (with or without Broenstedt acid catalysis) or as two-component systems through admixture of silicic esters or organotin compounds. Hydrosilylation is another possibility in vinyl-silane systems.

Unsaturated compounds, for example acryloyl-functional polymers or unsaturated esters, are crosslinkable with amines or thiols. Cationic vinyl ether polymerization is also possible.

However, it is particularly preferable for the matrix polymers to be in a crosslinked state, preferably in a three-dimensionally crosslinked state and most preferably to be three-dimensionally crosslinked polyurethanes. Polyurethane matrix polymers are obtainable in particular by reacting at least one polyisocyanate component a) with at least one isocyanate-reactive component b).

The polyisocyanate component a) comprises at least one organic compound having at least two NCO groups. These organic compounds may comprise in particular monomeric di- and triisocyanates, polyisocyanates and/or NCO-functional prepolymers. The polyisocyanate component a) may also contain or consist of mixtures of monomeric di- and triisocyanates, polyisocyanates and/or NCO-functional prepolymers.

Useful monomeric di- and triisocyanates include any compounds well known per se to the skilled person, or mixtures thereof. These compounds may have aromatic, araliphatic, aliphatic or cycloaliphatic structures. The monomeric di- and triisocyanates may also comprise minor amounts of monoisocyanates, i.e. organic compounds having one NCO group.

Examples of suitable monomeric di- and triisocyanates are 1,4-butane diisocyanate, 1,5-pentane diisocyanate, 1,6-hexane diisocyanate (hexamethylene diisocyanate, HDI), 2,2,4-trimethylhexamethylene diisocyanate and/or 2,4,4-trimethylhexamethylene diisocyanate (TMDI), isophorone diisocyanate (IPDI), 1,8-diisocyanato-4-(isocyanatomethyl)octane, bis(4,4′-isocyanatocyclohexyl)methane and/or bis(2′,4-isocyanatocyclohexyl)methane and/or their mixtures of any desired isomeric content, 1,4-cyclohexane diisocyanate, the isomeric bis(isocyanatomethyl)cyclohexanes, 2,4- and/or 2,6-diisocyanato-1-methylcyclohexane (hexahydro-2,4- and/or 2,6-tolylene diisocyanate, H₆-TDI), 1,4-phenylene diisocyanate, 2,4- and/or 2,6-tolylene diisocyanate (TDI), 1,5-naphthylene diisocyanate (NDI), 2,4′- and/or 4,4′-diphenylmethane diisocyanate (MDI), 1,3-bis(isocyanatomethyl)benzene (XDI) and/or the analogous 1,4-isomer or any desired mixtures of the aforementioned compounds.

Suitable polyisocyanates are compounds having urethane, urea, carbodiimide, acylurea, amide, isocyanurate, allophanate, biuret, oxadiazinetrione, uretdione and/or iminooxadiazinedione structures that are obtainable from the aforementioned di- or triisocyanates.

The polyisocyanates are more preferably oligomerized aliphatic and/or cycloaliphatic di- or triisocyanates, in which case particularly the above aliphatic and/or cycloaliphatic di- or triisocyanates are usable.

Polyisocyanates having isocyanurate, uretdione and/or iminooxadiazinedione structures and also biurets based on HDI or mixtures thereof are very particularly preferable.

Suitable prepolymers contain urethane and/or urea groups and possibly also further structures as mentioned above, formed by modification of NCO groups. Prepolymers of this type are obtainable, for example, by reacting the abovementioned monomeric di- and triisocyanates and/or polyisocyanates a1) with isocyanate-reactive compounds b1).

Useful isocyanate-reactive compounds b1) include alcohols, amino or mercapto compounds, preferably alcohols. Polyols may in this case be concerned in particular. Polyester, polyether, polycarbonate, poly(meth)acrylate and/or polyurethane polyols are very particularly preferable for use as isocyanate-reactive compound b1).

Useful polyester polyols include, for example, linear polyester diols or branched polyester polyols, which are obtainable in a known manner by reaction of aliphatic, cycloaliphatic or aromatic di- and/or polycarboxylic acids and/or anhydrides with polyhydric alcohols having an OH functionality ≥2. Examples of suitable di- and polycarboxylic acids are polybasic carboxylic acids such as succinic acid, adipic acid, suberic acid, sebacic acid, decanedicarboxylic acid, phthalic acid, terephthalic acid, isophthalic acid, tetrahydrophthalic acid and trimellitic acid and also anhydrides such as phthalic anhydride, trimellitic anhydride or succinic anhydride or any desired mixtures thereof. Polyester polyols may also be based on natural raw materials such as castor oil. It is likewise possible for the polyester polyols to be based on homo- or interpolymers of lactones, which are obtainable in a preferred manner by addition reaction of lactones and/or lactone mixtures such as butyrolactone, ε-caprolactone and/or methyl-ε-caprolactone onto hydroxyl-functional compounds such as polyhydric alcohols having an OH functionality ≥2 for example of the type recited hereinbelow.

Examples of suitable alcohols are any polyhydric alcohols such as, for example, the C₂-C₁₂ diols, the isomeric cyclohexanediols, glycerol or any desired mixtures thereamong.

Suitable polycarbonate polyols are obtainable in a conventional manner by reaction of organic carbonates or phosgene with diols or diol mixtures.

Suitable organic carbonates are dimethyl carbonate, diethyl carbonate and diphenyl carbonate.

Suitable diols and/or mixtures include the ≥2 OH functionality polyhydric alcohols recited per se in connection with the polyester segments, preferably 1,4-butanediol, 1,6-hexanediol and/or 3-methylpentanediol. Polyester polyols may similarly be converted into polycarbonate polyols.

Suitable polyether polyols are optionally blockwise polyaddition products of cyclic ethers onto HO- or HN-functional starter molecules.

Suitable cyclic ethers are, for example, styrene oxides, ethylene oxide, propylene oxide, tetrahydrofuran, butylene oxide, epichlorohydrin and also any desired mixtures thereof.

Useful starters include the ≥2 OH functionality polyhydric alcohols recited per se in connection with the polyester polyols and also primary or secondary amines and aminoalcohols.

Preferred polyether polyols are those of the aforementioned type which are exclusively based on propylene oxide or random or block copolymers based on propylene oxide with further 1-alkylene oxides. Particular preference is given to propylene oxide homopolymers and also random or block copolymers having oxyethylene, oxypropylene and/or oxybutylene units, where the proportion of oxypropylene units comprises not less than 20 wt %, preferably not less than 45 wt %, of the total amount of all oxyethylene, oxypropylene and oxybutylene units. Oxypropylene and oxybutylene here include any respective linear and branched C₃ and C₄ isomers.

Additionally useful as constituents of polyol component b1), as polyfunctional isocyanate-reactive compounds, are further low molecular weight (i.e. with molecular weights ≤500 g/mol), short-chain (i.e. containing 2 to 20 carbon atoms), aliphatic, araliphatic or cycloaliphatic di-, tri- or polyfunctional alcohols.

Examples thereof, in addition to the abovementioned compounds, include neopentyl glycol, 2-ethyl-2-butylpropanediol, trimethylpentanediol, positionally isomeric diethyloctanediols, cyclohexanediol, 1,4-cyclohexanedimethanol, 1,6-hexanediol, 1,2-cyclohexanediol, 1,4-cyclohexanediol, hydrogenated bisphenol A, 2,2-bis(4-hydroxycyclohexyl)propane or 2,2-dimethyl-3-hydroxypropyl 2,2-dimethyl-3-hydroxypropionate. Examples of suitable triols are trimethylolethane, trimethylolpropane or glycerol. Suitable alcohols of higher functionality are di(trimethylolpropane), pentaerythritol, dipentaerythritol or sorbitol.

It is particularly preferable for the polyol component to be a difunctional polyether, polyester or polyether-polyester block copolyester or a polyether-polyester block copolymer having primary OH functions.

It is likewise possible to use amines as isocyanate-reactive compounds b1). Examples of suitable amines are ethylenediamine, propylenediamine, diaminocyclohexane, 4,4′-dicyclohexylmethane diamine, isophoronediamine (IPDA), difunctional polyamines such as, for example, the Jeffamines®, amine-terminated polymers, in particular with number-average molar masses ≤10 000 g/mol. Mixtures of the aforementioned amines can likewise be used.

It is likewise possible to use aminoalcohols as isocyanate-reactive compounds b1). Examples of suitable aminoalcohols are the isomeric aminoethanols, the isomeric aminopropanols, the isomeric aminobutanols and the isomeric aminohexanols or any desired mixtures thereof.

Any aforementioned isocyanate-reactive compounds b1) may be mixed with each other in any desired manner.

It is also preferable for the isocyanate-reactive compounds b1) to have a number-average molar mass of ≥200 and ≤10 000 g/mol, more preferably ≥500 and ≤8000 g/mol and most preferably ≥800 and ≤5000 g/mol. Polyol OH functionality is preferably in the range from 1.5 to 6.0, more preferably in the range from 1.8 to 4.0.

The residual level of free monomeric di- and triisocyanates in the prepolymers of polyisocyanate component a) may be in particular <1 wt %, more preferably <0.5 wt % and most preferably <0.3 wt %.

It is optionally also possible for polyisocyanate component a), entirely or in part, to contain organic compounds where blocking agents known from coatings technology are blocking some or all of the NCO groups thereof. Examples of blocking agents are alcohols, lactams, oximes, malonic esters, pyrazoles and also amines, e.g. butanone oxime, diisopropylamine, diethyl malonate, ethyl acetoacetate, 3,5-dimethylpyrazole, ε-caprolactam or mixtures thereof.

It is particularly preferable when polyisocyanate component a) comprises compounds having aliphatically attached NCO groups, where aliphatically attached NCO groups are to be understood as NCO groups that are attached via a primary carbon atom. The isocyanate-reactive compound b) preferably comprises at least one organic compound having on average at least 1.5 and preferably from 2 to 3 isocyanate-reactive groups. Isocyanate-reactive groups for the purposes of the present invention are preferably hydroxyl, amino or mercapto groups.

The isocyanate-reactive component may particularly comprise compounds having on number average at least 1.5 and preferably from 2 to 3 isocyanate-reactive groups.

The b1) compounds described above are examples of polyfunctional isocyanate-reactive compounds useful as component b).

It is also very particularly preferable when the polyurethanes are based on polyester C4-polyether polyols.

Photoinitiators of component b) are typically compounds activatable by actinic radiation and capable of initiating a polymerization of writing monomers. There are unimolecular photoinitiators (type I) and bimolecular photoinitiators (type II). Photoinitiators are further classified by their chemistry into photoinitiators for free-radical, anionic, cationic or mixed types of polymerization.

Type I photoinitiators (Norrish type I) for free-radical photopolymerization form free radicals on irradiation through unimolecular bond scission. Examples of type I photoinitiators are triazines, oximes, benzoin ethers, benzil ketals, bisimidazoles, aroylphosphine oxides, sulphonium salts and iodonium salts.

Type II photoinitiators (Norrish type II) for free-radical polymerization consist of a dye as sensitizer and a co-initiator and undergo a bimolecular reaction on irradiation with light appropriate to the dye. The dye initially absorbs a photon and transfers energy from an excited state to the co-initiator. The co-initiator, by electron or proton transfer or direct hydrogen abstraction, releases the free radicals which initiate the polymerization.

The use of type II photoinitiators is preferred for the purposes of this invention.

Photoinitiator systems of this type are described in principle in EP 0 223 587 A and preferably consist of a mixture of one or more dyes with ammonium alkylarylborate(s).

Suitable dyes, which combine with an ammonium alkylarylborate to form a type II photoinitiator, are the cationic dyes described in WO 2012062655 when used in combination with the anions likewise described therein.

Cationic dyes are preferably cationic dyes of the following classes: acridine dyes, xanthene dyes, thioxanthene dyes, phenazine dyes, phenoxazine dyes, phenothiazine dyes, tri(het)arylmethane dyes—particularly diamino- and triamino(het)arylmethane dyes, mono-, di-, tri- and pentamethinecyanine dyes, hemicyanine dyes, externally cationic merocyanine dyes, externally cationic neutrocyanine dyes, zeromethine dyes—particularly naphtholactam dyes, streptocyanine dyes. Dyes of this type are described by way of example in H. Berneth in Ullmann's Encyclopedia of Industrial Chemistry, Azine Dyes, Wiley-VCH Verlag, 2008, H. Berneth in Ullmann's Encyclopedia of Industrial Chemistry, Methine Dyes and Pigments, Wiley-VCH Verlag, 2008, T. Gessner, U. Mayer in Ullmann's Encyclopedia of Industrial Chemistry, Triarylmethane and Diarylmethane Dyes, Wiley-VCH Verlag, 2000.

Particular preference is given to the phenazine dyes, phenoxazine dyes, phenothiazine dyes, tri(het)arylmethane dyes—particularly diamino- and triamino(het)arylmethane dyes, mono-, di-, tri- and pentamethinecyanine dyes, hemicyanine dyes, zeromethine dyes—particularly naphtholactam dyes, streptocyanine dyes.

Examples of cationic dyes are Astrazon Orange G, Basic Blue 3, Basic Orange 22, Basic Red 13, Basic Violet 7, Methylene Blue, New Methylene Blue, Azure A, 2,4-diphenyl-6-(4-methoxyphenyl)pyrylium, Safranin O, astraphloxine, Brilliant Green, crystal violet, ethyl violet and thionine.

Preferred anions are particularly C₈- to C₂₅-alkanesulphonate, preferably C₁₃- to C₂₅-alkanesulphonate, C₃- to C₁₈-perfluoroalkanesulphonate, C₄- to C₁₈-perfluoroalkanesulphonate bearing 3 or more hydrogen atoms in the alkyl chain, C₉- to C₂₅-alkanoate, C₉- to C₂₅-alkenoate, C₈- to C₂₅-alkyl sulphate, preferably C₁₃- to C₂₅-alkyl sulphate, C₈- to C₂₅-alkenyl sulphate, preferably C₁₃- to C₂₅-alkenyl sulphate, C₃- to C₁₈-perfluoroalkyl sulphate, C₄- to C₁₈-perfluoroalkyl sulphate bearing 3 or more hydrogen atoms in the alkyl chain, polyether sulphates based on at least 4 equivalents of ethylene oxide and/or 4 equivalents of propylene oxide, bis(C₄- to C₂₅-alkyl, C₅- to C₇-cycloalkyl-, C₃- to C₈-alkenyl or C₇- to C₁₁-aralkyl) sulphosuccinate, bis(C₂- to C₁₀-alkyl) sulphosuccinate substituted by 8 or more fluorine atoms, C₈- to C₂₅-alkyl sulphoacetates, benzenesulphonate substituted by one or more of halogen, C₄- to C₂₅-alkyl, perfluoro-C₁- to C₈-alkyl and/or C₁- to C₁₂-alkoxycarbonyl; optionally nitro-, cyano-, hydroxyl-, C₁- to C₂₅-alkyl-, C₁- to C₁₂-alkoxy-, amino-, C₁- to C₁₂-alkoxycarbonyl- or chlorine-substituted naphthalene- or biphenylsulphonate, optionally nitro-, cyano-, hydroxyl-, C₁- to C₂₅-alkyl-, C₁- to C₁₂-alkoxy-, C₁- to C₁₂-alkoxycarbonyl- or chlorine-substituted benzene-, naphthalene- or biphenyldisulphonate, dinitro-, C₆- to C₂₅-alkyl-, C₄- to C₁₂-alkoxycarbonyl-, benzoyl-, chlorobenzoyl- or toluoyl-substituted benzoate, the anion of naphthalenedicarboxylic acid, diphenyl ether disulphonate, sulphonated or sulphated, optionally at least one unsaturated C₈- to C₂₅-fatty acid ester of aliphatic C₁- to C₈-alcohols or glycerol, bis(sulpho-C₂- to C₆-alkyl) C₃- to C₁₂-alkanedicarboxylates, bis(sulpho-C₂- to C₆-alkyl) itaconates, (sulpho-C₂- to C₆-alkyl) C₆- to C₁₈-alkanecarboxylates, (sulpho-C₂- to C₆-alkyl) acrylates or methacrylates, triscatechol phosphate optionally substituted by up to 12 halogen moieties, an anion from the group tetraphenylborate, cyanotriphenylborate, tetraphenoxyborate, C₄- to C₁₂-alkyltriphenylborate whose phenyl or phenoxy moieties may be halogen, C₁- to C₄-alkyl and/or C₁- to C₄-alkoxy substituted, C₄- to C₁₂-alkyltrinaphthylborate, tetra-C₁- to C₂₀-alkoxyborate, 7,8- or 7,9-dicarbanidoundecaborate(1−) or (2−), optionally substituted by one or two C₁- to C₁₂-alkyl or phenyl groups on the boron and/or carbon atoms, dodecahydrodicarbadodecaborate(2−) or B—C₁- to C₁₂-alkyl-C-phenyldodecahydrodicarbadodecaborate(1−), where in the case of polyvalent anions such as naphthalencdisulphonate A⁻ represents one equivalent of this anion, and where the alkane and alkyl groups may be branched and/or halogen, cyano, methoxy, ethoxy, methoxycarbonyl or ethoxycarbonyl substituted.

It is also preferable for the anion A⁻ of the dye to have an AC log P in the range from 1 to 30, more preferably in the range from 1 to 12 and yet more preferably in the range from 1 to 6.5. The AC log P is computed according to J. Comput. Aid. Mol. Des. 2005, 19, 453; Virtual Computational Chemistry Laboratory, http://www.vcclab.org.

Suitable ammonium alkylarylborates include for example (Cunningham et al., RadTech'98 North America UV/EB Conference Proceedings, Chicago, Apr. 19-22, 1998); tetrabutylammonium triphenylhexylborate, tetrabutylammonium triphenylbutylborate, tetrabutylammonium trinaphthylhexylborate, tetrabutylammonium tris(4-tert.butyl)phenylbutylborate, tetrabutylammonium tris(3-fluorophenyl)hexylborate ([191726-69-9], CGI 7460, product from BASF SE, Basel, Switzerland), 1-methyl-3-octylimidazolium dipentyldiphenylborate and tetrabutylammonium tris(3-chloro-4-methylphenyl)hexylborate ([1147315-11-4], CGI 909, product from BASF SE, Basel, Switzerland).

It may be advantageous to use mixtures of these photoinitiators. Depending on the source of radiation used, photoinitiator type and concentration has to be conformed in a manner known to a person skilled in the art. Further details are described for example in P. K. T. Oldring (Ed.), Chemistry & Technology of UV & EB Formulations For Coatings, Inks & Paints, Vol. 3, 1991, SITA Technology, London, pp. 61-328.

It is very particularly preferable when the photoinitiator comprises a combination of dyes whose absorption spectra at least partly cover the spectral region from 400 to 800 nm with at least one co-initiator appropriate to the dyes.

It is also preferable for the photopolymer formulation to include at least one photoinitiator suitable for one laser light colour selected from blue, green and red.

It is further also preferable for the photopolymer formulation to include a suitable photoinitiator for each of at least two laser light colours selected from blue, green and red.

It is finally very particularly preferable for the photopolymer formulation to include a suitable photoinitiator for each of the laser light colours blue, green and red.

Particularly high refractive index contrasts are obtainable when the photopolymer formation comprises an acrylate- or methacrylate-functional writing monomer. Particular preference here is given to monofunctional writing monomers and particularly to those monofunctional urethane (meth)acrylates described in US 2010/0036013 A1.

Suitable acrylate-type writing monomers are particularly compounds of general formula

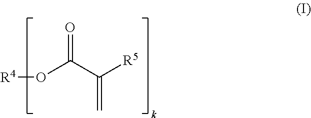

where in each case k is ≥1 and ≤4 and R⁴ is a linear, branched, cyclic or heterocyclic unsubstituted or else optionally even heteroatom-substituted organic moiety and/or R⁵ is hydrogen, a linear, branched, cyclic or heterocyclic unsubstituted or optionally even heteroatom-substituted organic moiety. It is particularly preferable for R⁵ to be hydrogen or methyl and/or for R⁴ to be a linear, branched, cyclic or heterocyclic unsubstituted or else optionally even heteroatom-substituted organic moiety.

The terms acrylates and methacrylates herein refer to esters of, respectively, acrylic acid and methacrylic acid. Examples of preferred acrylates and methacrylates are phenyl acrylate, phenyl methacrylate, phenoxyethyl acrylate, phenoxyethyl methacrylate, phenoxyethoxyethyl acrylate, phenoxyethoxyethyl methacrylate, phenylthioethyl acrylate, phenylthioethylmethacrylate, 2-naphthyl acrylate, 2-naphthyl methacrylate, 1,4-bis(2-thionaphthyl)-2-butylacrylate, 1,4-bis(2-thionaphthyl)-2-butyl methacrylate, bisphenol A diacrylate, bisphenol A dimethacrylate, and also their ethoxylated analogues, N-carbazolyl acrylates.

Urethane acrylates herein are to be understood as compounds having at least one acrylic ester group and at least one urethane bond. Compounds of this type are obtainable, for example, by reacting a hydroxyl-functional acrylate or methacrylate with an isocyanate-functional compound.

Examples of isocyanate-functional compounds useful for this are monoisocyanates and also the monomeric diisocyanates, triisocyanates and/or polyisocyanates referred to under a). Examples of suitable monoisocyanates are phenyl isocyanate, the isomeric methylthiophenyl isocyanates. Di-, tri- or polyisocyanates are mentioned above and also triphenylmethane 4,4′,4″-triisocyanate and tris(p-isocyanatophenyl) thiophosphate or derivatives thereof having a urethane, urea, carbodiimide, acylurea, isocyanurate, allophanate, biuret, oxadiazinetrione, uretdione, iminooxadiazinedione structure and mixtures thereof. Aromatic di-, tri- or polyisocyanates are preferable among these.

Useful hydroxyl-functional acrylates or methacrylates for the manufacture of urethane acrylates include, for example, compounds such as 2-hydroxyethyl (meth)acrylate, polyethylene oxide mono(meth)acrylates, polypropylene oxide mono(meth)acrylates, polyalkylene oxide mono(meth)acrylates, poly(ε-caprolactone) mono(meth)acrylates, for example Tone® M100 (Dow, Schwalbach, DE), 2-hydroxypropyl (meth)acrylate, 4-hydroxybutyl (meth)acrylate, 3-hydroxy-2,2-dimethylpropyl (meth)acrylate, hydroxypropyl (meth)acrylate, 2-hydroxy-3-phenoxypropyl acrylate, the hydroxyl-functional mono-, di- or tetraacrylates of polyhydric alcohols such as trimethylolpropane, glycerol, pentaerythritol, dipentaerythritol, ethoxylated, propoxylated or alkoxylated trimethylolpropane, glycerol, pentaerythritol, dipentaerythritol or technical grade mixtures thereof. 2-Hydroxyethyl acrylate, hydroxypropyl acrylate, 4-hydroxybutyl acrylate and poly(ε-caprolactone) mono(meth)acrylate are preferable.

It is likewise possible to use the familiar hydroxyl-containing epoxy (meth)acrylates having OH contents of 20 to 300 mg KOH/g or hydroxyl-containing polyurethane (meth)acrylates having OH contents of 20 to 300 mg KOH/g or acrylated polyacrylates having OH contents of 20 to 300 mg KOH/g and also their mixtures with each other and mixtures with hydroxyl-containing unsaturated polyesters and also mixtures with polyester (meth)acrylates or mixtures of hydroxyl-containing unsaturated polyesters with polyester (meth)acrylates.

Preference is given particularly to urethane acrylates obtainable from the reaction of tris(p-isocyanatophenyl) thiophosphate and/or m-methylthiophenyl isocyanate and/or o-phenylthiophenyl acrylate and/or o-biphenylacrylate with alcohol-functional acrylates such as hydroxyethyl (meth)acrylate, hydroxypropyl (meth)acrylate and/or hydroxybutyl (meth)acrylate.

It is similarly possible for the writing monomer to comprise or consist of further unsaturated compounds such as α,β-unsaturated carboxylic acid derivatives such as, for example, maleates, fumarates, maleimides, acrylamides, further vinyl ethers, propenyl ethers, allyl ethers and dicyclopentadienyl-containing compounds and also olefinically unsaturated compounds such as, for example, styrene, α-methylstyrene, vinyltoluene and/or olefins.

A further preferred embodiment provides that the photopolymer further comprises monomeric fluorourethanes.

It is particularly preferable for the fluorourethanes to comprise or consist of at least one compound of formula (II)

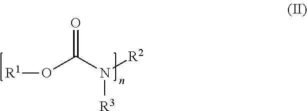

where n is ≥1 and ≤8 and R¹, R² and R³ are each independently hydrogen, linear, branched, cyclic or heterocyclic unsubstituted or optionally even heteroatom-substituted organic moieties, where preferably at least one of R¹, R² and R³ is substituted with at least one fluorine atom and more preferably R¹ is an organic moiety having at least a fluorine atom.

A further preferred embodiment of the invention provides that the photopolymer contains from 10 to 89.999 wt %, preferably from 20 to 70 wt % of matrix polymers, from 3 to 60 wt %, preferably from 10 to 50 wt % of writing monomers, from 0.001 to 5 wt %, preferably from 0.5 to 3 wt % of photoinitiators and optionally from 0 to 4 wt %, preferably from 0 to 2 wt % of catalysts, from 0 to 5 wt %, preferably from 0.001 to 1 wt % of stabilizers, from 0 to 40 wt %, preferably from 10 to 30 wt % of monomeric fluorourethanes and from 0 to 5 wt %, preferably from 0.1 to 5 wt % of further additives, subject to the proviso that the sum total of all constituents is 100 wt %.

Particular preference is given to using photopolymers having from 20 to 70 wt % of matrix polymers, from 20 to 50 wt % of writing monomers, from 0.001 to 5 wt % of photoinitiators, from 0 to 2 wt % of catalysts, from 0.001 to 1 wt % of free-radical stabilizers, optionally from 10 to 30 wt % of fluorourethanes and optionally from 0.1 to 5 wt % of further additives.

Useful catalysts include urethanization catalysts, for example organic or inorganic derivatives of bismuth, of tin, of zinc or of iron (see also the compounds recited in US 2012/062658). Particularly preferred catalysts are butyltin tris(2-ethylhexanoate), iron(III) tris(acetylacetonate, bismuth(III) tris(2-ethylhexanoate) and tin(II) bis(2-ethylhexanoate). Sterically hindered amines are further also usable as catalysts.

Useful stabilizers include free-radical inhibitors such as HALS amines, N-alkyl-HALS, N-alkoxy-HALS and N-alkoxyethyl-HALS compounds and also antioxidants and/or UV absorbers.

By way of further additives it is possible to use flow assistants and/or antistats and/or thixotropic agents and/or thickeners and/or biocides.

Photopolymer layer B is in particular a photopolymer layer which, after exposure to UV radiation, has a mechanical modulus Guy in the range between 0.1 and 160 MPa. In particular, the exposed holographic media may have a Guy modulus in the range between 0.3 and 40 MPa, preferably between 0.7 and 15 MPa.

Sealing layer C is less than 50 μm in thickness and has a viscosity of 2000 Pa s to 2 million Pa s, preferably 4000 Pa s to 1.6 million Pa s. Before curing with actinic radiation, sealing layer C comprises a physically drying resin C1, selectively an acryloyl-functional reactive diluent C2 and a photoinitiator C3. Sealing layer C preferably further comprises a UV absorber in an amount of 0.1 to 10 wt %.

The physically drying resin C1 comprises amorphous thermoplastics which are room temperature solid and/or vitreous and soluble in suitable solvents, for example amorphous polyesters, preferably linear polyesters (e.g. Dynacoll S1606, Evonik Industries AG, Marl, Germany); amorphous polycarbonates (e.g. APEC 1895, Covestro DeutschlandBayer MaterialScience AG, Leverkusen, Germany), amorphous polyacrylates, e.g. amorphous polymethyl methacrylate (e.g.: Degalan M825, or Degalan M345, Degalan M920, Degacryl M547, Degacryl M727, Dagacryl MW730, Degacryl 6962 F, from Evonik Industries AG, Marl, Germany); amorphous polystyrenes, amorphous polystyrene-methyl methacrylate copolymers (e.g.: NAS 90, NAS 21 from Styrolution Group GmbH, Frankfurt am Main, Germany), styrene-acrylonitrile copolymer (e.g. Luran 358N from Styrolution Group GmbH, Frankfurt am Main, Germany); acrylonitrile copolymers and amorphous acrylonitrile-butadiene copolymers (ABS). It is further also possible to use acryloyl-functional polyacrylates, for example those obtainable from the free-radical copolymerization of monofunctional acrylates and methacrylates with epoxy-functional (meth)acrylate monomers (e.g. glycidyl methacrylate) and which are then obtainable in a subsequent epoxide addition of acrylic acid (e.g. Ebecryl 1200, Allnex, Brussels, Belgium, an acryloyl-functional polyacrylate with 4 mol/kg of double bond density). It is likewise possible to use epoxy-acrylates (e.g. adducts of epoxides of bisphenol A with acrylic acid). Amorphous polymethyl methacrylate and acrylate-functional polyacrylates are preferable.

The acryloyl-functional reactive diluent C2 contains or consists of one or more by radiation curing compounds having one or more by radiation curing free-radically polymerizable groups per molecule, which are preferably acryloyl, methacryloyl, allyl, vinyl, maleoyl and/or fumaroyl groups, more preferably acryloyl and/or methacryloyl groups and most preferably acryloyl groups.

Acryloyl-functional reactive diluents C2 are preferably esters of acrylic or methacrylic acid with aliphatic alcohols or with aliphatic ethers, which may likewise also contain aromatic sub-structures.

Selected examples having one acrylate group are caprolactone acrylate, tetrahydrofuirfuryl acrylate, ethoxylated phenol acrylate, monofunctional epoxy-acrylates, phenoxyethyl acrylate, isobornyl acrylate, octyl acrylate, isooctyl acrylate, decyl acrylate, lauryl acrylate, tridecyl acrylate, isodecyl acrylate, stearyl acrylate, cyclotrimethylolpropaneformal acrylate, trimethylcyclohexyl acrylate, benzyl acrylate, phenyl ethoxyacrylate, phenyl diethoxyacrylate, phenyl tetraethoxyacrylate, nonylphenol tetraethoxyacrylate, nonyl phenoxyoctaethoxyacrylate, nonylphenol dipropoxyacrylate.

Suitable difunctional acryloyl-functional reactive diluents C2 are tricyclodecanediol diacrylate, propoxylated neopentyl glycol diacrylate, dipropylene glycol diacrylate, 1,6-hexanediol diacrylate, ethoxylated hexanediol diacrylate, tripropylene glycol diacrylate, hydroxypivalic acid neopentyl glycol diacrylate, neopentyl glycol dipropoxydiacrylate, tripropylene glycol diacrylate, dipropylene glycol diacrylate, triethylene glycol diacrylate, ethoxylated bisphenol A diacrylate, tricyclodecanedimethanol diacrylate, tetraethylene glycol diacrylate, polyethylene glycol diacrylate, polyethylene glycol diacrylates, polypropylene glycol diacrylates.

Suitable trifunctional acryloyl-functional reactive diluents C2 are trimethylolpropane triacrylate, trimethylolpropane (poly)ethoxytriacrylate, glycerol propoxyacrylate, pentaerythritol triacrylate, trimethylolpropane tripropoxytriacrylate, tris(2-hydroxyethyl) isocyanurate triacrylate, and also allophanate-based urethane acrylates (e.g. Desmolux XP2740 from Allnex, Brussels, Belgium).

Suitable acryloyl-functional reactive diluents C2 of higher functionality are dipentaerythritol pentaacrylate, dipentaerythritol hexaacrylate, ditrimethylolpropane tetraacrylate, ethoxylated pentaerythritol tri- and tetraacrylate, pentaerythritol tetraacrylate, glycerol propoxylate triacrylate with 0.3-9 propoxy units, glycerol ethoxylate triacrylate with 0.3-9 ethoxy units.

The abovementioned acrylic esters are further also usable as analogous methacrylic esters. Also possible are mixtures of the recited acrylates with each other and of the analogous methacrylates between each other and mixtures of acrylates and methacrylates.

Preference is given to ditrimethylolpropanetetraacrylate, ethoxylated pentaerythritol tetraacrylate, phenyl ethoxyacrylate, phenyl diethoxyacrylate, phenyl triethoxyacrylate, phenyl tetraethoxyacrylate, nonylphenol tetraethoxyacrylate, nonyl phenoxyoctaethoxyacrylate, nonylphenol dipropoxyacrylate. Ditrimethylolpropane tetraacrylate and phenyl di- and triethoxyacrylate are particularly preferable.

Photoinitiators C3 used are typically compounds activatable by actinic radiation and capable of initiating a polymerization of the corresponding groups.

There are unimolecular photoinitiators C3 (type I) and bimolecular photoinitiators (type II) for free-radical polymerization; there is extensive prior art on this.

Type I photoinitiators (Norrish type I) for free-radical photopolymerization form free radicals on irradiation through unimolecular bond scission.

Examples of type I photoinitiators are triazines, e.g. tris(trichloromethyl)triazine, oximes, benzoin ethers, benzil ketals, alpha,alpha-dialkoxyacetophenone, phenylglyoxylic esters, bisimidazoles, aroylphosphine oxides, e.g. 2,4,6-trimethylbenzoyldiphenylphosphine oxide, sulphonium salts and iodonium salts.

Type II photoinitiators (Norrish type II) for free-radical polymerization undergo on irradiation a bimolecular reaction wherein the photoinitiator in the excited state reacts with a second molecule, the co-initiator, and forms the polymerization-initiating free radicals by electron or proton transfer or direct hydrogen abstraction.

Examples of type II photoinitiators are quinones, e.g. camphoroquinone, aromatic keto compounds, e.g. benzophenones in combination with tertiary amines, alkylbenzophenones, halogenated benzophenones, 4,4′-bis(dimethylamino)benzophenone (Michler's ketone), anthrone, methyl p-(dimethylamino)benzoate, thioxanthone, ketocoumarins, alpha-aminoalkylphenone, alpha-hydroxyalkylphenone and cationic dyes, for example methylene blue, in combination with tertiary amines.

Type I and type II photoinitiators are used for the UV and short-wave visible region, while predominantly type II photoinitiators are used for the comparatively long-wave visible spectrum.

Preference is given to 1-hydroxycyclohexyl phenyl ketone (e.g. Irgacure® 184 from BASF SE), 2-hydroxy-2-methyl-1-phenyl-1-propanone (e.g. Irgacure® 1173 from BASF SE), 2-hydroxy-1-{4-[4-(2-hydroxy-2-methylpropionyl)benzyl]phenyl}-2-methylpropan-1-one (e.g. Irgacure® 127 from BASF SE), 2-hydroxy-1-[4-(2-hydroxyethoxy)phenyl]-2-methyl-1-propanone (e.g. Irgacure® 2959 from BASF SE); 2,4,6-trimethylbenzoyldiphenylphosphine oxide (e.g. Lucirin® TPO from BASF SE); 2,4,6-trimethylbenzoyldiphenyl phosphinate (e.g. Lucirin® TPO-L from BASF SE), bis(2,4,6-trimethylbenzoyl)phenylphosphine oxide (Lucirin® 819); [1-(4-phenylsulphanylbenzoyl)heptylideneamino] benzoate (e.g. Irgacure® OXE 01 from BASF SE); [1-[9-ethyl-6-(2-methylbenzoyl)carbazol-3-yl]ethylideneamino]acetate (e.g. Irgacure® OXE 02 from BASF SE) and also mixtures thereof. Particular preference is given to 2-hydroxy-2-methyl-1-phenyl-1-propanone and 2,4,6-trimethylbenzoyldiphenylphosphine oxides and also mixtures thereof.

Typical UV absorbers are benzotriazoles, cyanoacrylates, benzophenones, phenyltriazines, hydroxyphenyltriazines or oxalanilides.

Photoprotectants such as phenols or HALS amines may further be included. Substrate layer D is suitably a mechanically stable thermoplastic substrate in plastic, in particular in polyester, e.g. polyethylene terephthalate (PET) or polybutylene terephthalate, high impact poly with a layer thickness of <200 μm, <100 μm and >20 μm, preferably <45 μm and >20 μm, having reduced adhesion properties as a result of surface modification. Various techniques come into consideration for this. Thus, inorganic types of gliding additives may be added, examples being kaolin, clay, fuller's earth, calcium carbonate, silicon dioxide, alumina, titanium oxide, calcium phosphate, added at up to 3%. To improve the optical properties of such films, three-layered co-extruded films where only the outer layers contain such inorganic types of gliding additives (e.g. Hostaphan RNK) are also used. It is further also possible to apply silicones to the surfaces to reduce surface tension and hence adherent properties.

The invention likewise provides the use of sealing film C to protect a photopolymer B.

The invention further provides the use of the above-described kit-of-parts for the similarly above-described process for producing an at least partly interconnected setup formed of at least 2 layers comprising
a) an areal photopolymer B containing a volume hologram, and
b) at least one at least partly actinically cured sealing layer C,
   characterized in that
the photopolymer B containing a volume hologram comprises a crosslinked matrix;
the sealing layer C is less than 50 μm in thickness and has a viscosity of 2000 Pa s to 2 million Pa s, preferably 4000 Pa s to 1.6 million Pa s and comprises a physically drying resin C1, an acryloyl- or methacryloyl-functional reactive diluent C2 and a photoinitiator C3;
and the sealing layer C is laminated onto the photopolymer B and
thereafter cured with actinic radiation.

The invention further provides a sealed holographic medium obtainable by the process which the invention provides for producing an at least partly interconnected setup. In one embodiment, the holographic medium comprises a photopolymer layer containing a hologram and having a layer thickness of 0.3 μm to 500 μm, preferably of 0.5 μm to 200 μm and more preferably of 1 μm to 100 μm.

In particular, the hologram may be a reflection, transmission, in-line, off axis, full aperture transfer, white light transmission, Denisyuk, off axis reflection or edge lit hologram and also a holographic stereogram and preferably a reflection, transmission or edge lit hologram.

Possible optical functions of holograms correspond to the optical functions of light elements such as lenses, mirrors, deflecting mirrors, filters, diffuser lenses, directed diffusion elements, diffraction elements, light guides, waveguides, projection lenses and/or masks. In addition, two or more optical functions of this type may be combined in one such hologram, for example such that light is diffracted into a different direction depending on its angle of incidence. Setups of this type can be used for instance to build autostereoscopic or holographic electronic displays making it possible to experience a stereoscopic visual impression without further ancillary means such as, for example, a pair of polarizer or shutter glasses, the use in automotive head-up displays or head-mounted displays.

These optical elements often exhibit a specific type of frequency selectivity according to how the holograms were exposed and which dimensions the hologram has. This is important in particular on using monochromatic sources of light such as LEDs or laser light. One hologram is thus needed per complementary colour (RGB) in order to direct the light frequency-selectively and at the same time provide full-colour displays. Therefore, in certain display constructions, a plurality of holograms must be exposed inside each other in the medium.

In addition, the sealed holographic media of the present invention are also useful for producing holographic images or representations, for example for personal portraits, biometric representations in security documents, or generally of images or image structures for advertising, security tags, brand protection, branding, labels, design elements, decorations, illustrations, collectable cards, images and the like, and also images capable of representing digital data, including in combination with the products detailed above. Holographic images can have the impression of a three-dimensional image, but they may also represent image sequences, short films or a number of various objects, according to the angle from which and the light source with which (including moving light sources) etc. they are illuminated. Owing to this diversity of design possibilities, holograms, in particular volume holograms, are an attractive technical solution for the abovementioned application. It is also possible to use such holograms to store digital data by employing a very wide variety of exposure techniques (shift, spatial or angular multiplexing).

The invention likewise provides an optical display comprising a holographic medium of the present invention.

Examples of such optical displays are imaging displays based on liquid crystals, organic light-emitting diodes (OLEDs), LED display panels, microelectromechanical systems (MEMS) based on diffractive selection of light, electrowetting displays (E-ink) and plasma display screens. Optical displays of this type may be autostereoscopic and/or holographic displays, transmissive and reflective projection screens or projection lenses, displays having switchable restricted emission characteristics for privacy filters and bidirectional multiuser screens, virtual displays, head-up displays, head-mounted displays, illumination symbols, warning lamps, signalling lamps, floodlights and display panels.

The invention likewise provides autostereoscopic and/or holographic displays, projection screens, projection lenses, displays having switchable restricted emission characteristics for privacy filters and bidirectional multiuser screens, virtual displays, head-up displays, head-mounted displays, illumination symbols, warning lamps, signalling lamps, floodlights and display panels comprising a holographic medium of the invention.

Still further subjects of the invention are a security document and a holographically optical element comprising a holographic medium of the present invention.

In addition, the invention also provides for the use of a holographic medium of the present invention in the manufacture of chip cards, identity documents, 3D images, product protection labels, tags, banknotes or holographically optical elements particularly for optical displays.

### EXAMPLES

The invention will now be more particularly described by means of examples.

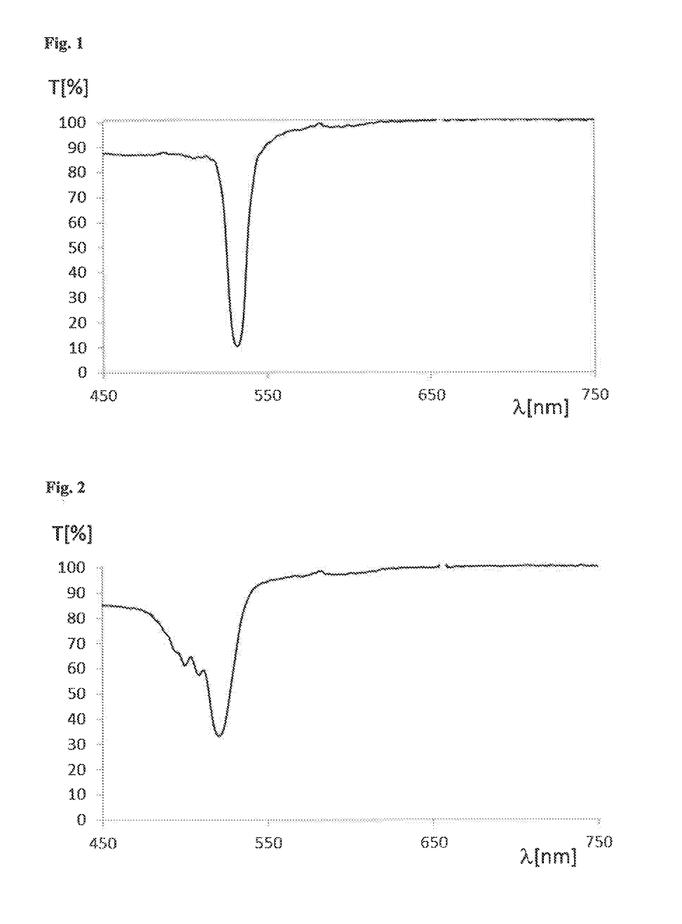

FIG. 1 shows the transmission spectrum of a reflection hologram recorded at 532 nm.

FIG. 2 shows the transmission spectrum of the FIG. 1 reflection hologram after adhesive bonding with an OCA (OCA-69604 UV-curing optically clear adhesive from Tesa SE, Norderstedt, Germany).

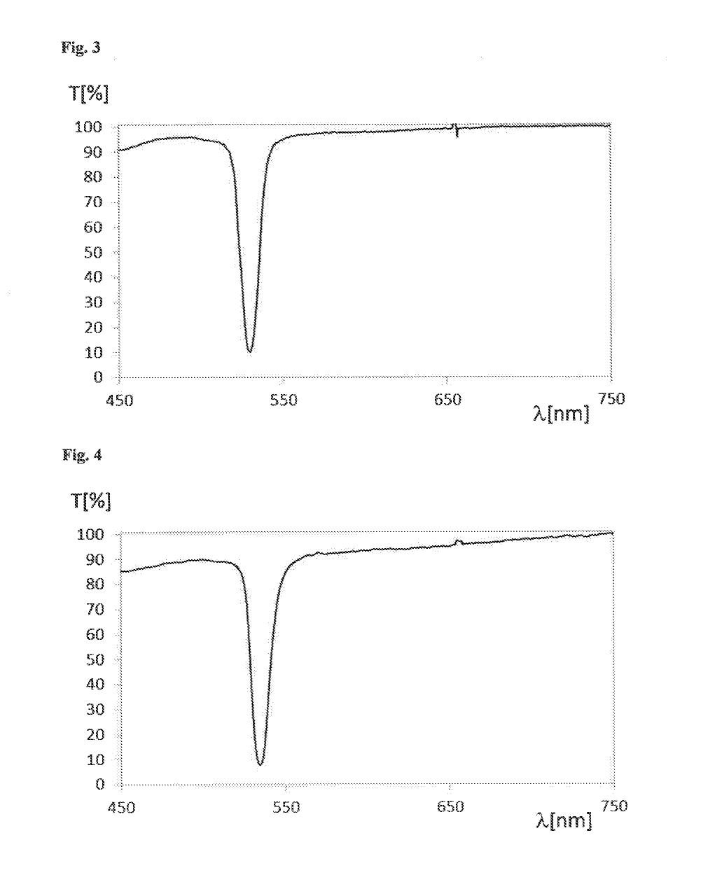

FIG. 3 shows the transmission spectrum of the test hologram for Example 1 of table 2 before sealing.

FIG. 4 shows the transmission spectrum of the test hologram for Example 1 of table 2 after sealing.

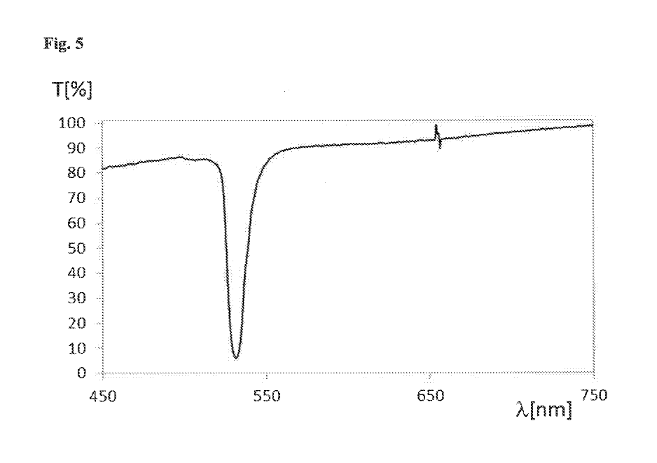

FIG. 5 shows the transmission spectrum of the test hologram for Example 1 of table 2 after sealing and after a thermal stress period of 24 hours/60° C.

### VISCOSITY MEASUREMENT

Sample preparation for determining the viscosity of sealing layer C took the form of pouring a corresponding solution from table 1, consisting of physically drying resin C1 and reactive diluent C2 dissolved in the organic solvent indicated therein, out onto a small plane-parallel Teflon pan. This was followed by drying in a vacuum drying cabinet at up to 60° C. The resulting film, about 1 mm in thickness and free from solvent odour, was cut out and measured on an Ares viscometer from Rheometrics. The viscosity was measured in the frequency sweep mode and in the plate-plate setup (14 mm diameter for measuring plates) sealed in a chamber temperature-regulated to 25° C. and reported for 1 Hz.

### Chemicals:

CAS numbers are reported where known between angular parentheses.

### Raw Materials of Photopolymer Layer B

| | |
|---|---|
| 2-hydroxyethyl acrylate | [818-61-1]-Sigma-Aldrich Chemie GmbH |
| | Steinheim, Germany |
| 2,6-di-tert-butyl-4-methylphenol | [128-37-0]-Merck KGaA, Darmstadt, Germany |
| 3-(methylthio)phenyl isocyanate | [28479-19-8]-Sigma-Aldrich Chemie GmbH |
| | Steinheim, Germany |
| Desmodur ® RFE | tris(p-isocyanatophenyl) thiophosphate, 27% |
| | strength in ethyl acetate, product from Covestro |
| | DeutschlandAG, Leverkusen, Germany |
| dibutyltin dilaurate | [77-58-7]-Sigma-Aldrich Chemie GmbH |
| | Steinheim, Germany |
| Fomrez ® UL 28 | Momentive Performance Chemicals, Wilton, CT, |
| | USA. |
| Borchi ® Kat 22 | [85203-81-2]-OMG Borchers GmbH, Langenfeld, |
| | Germany. |
| BYK-310 | BYK-Chernie GmbH, Wesel, Germany |
| Desmodur ® N 3900 | Covestro DeutschlandAG, Leverkusen, DE, hexane |
| | diisocyanate-based polyisocyanate, at least 30% |
| | proportion of iminooxadiazinedione, NCO content: |
| | 23.5%. |
| Desmorapid ® SO | [301-10-0]-Rhein Chemie Rheinau GmbH, |
| | Mannheim, Germany |
| CGI-909 | tetrabutylammonium tris(3-chloro-4- |
| | methylphenyl)-(hexyl)borate, |
| | [1147315-11-4], BASF SE |
| trimethylhexamethylene diisocyanate | [28679-16-5]-ABCR GmbH & Co KG, Karlsruhe, |
| | Germany |
| 1H,1H-7H-perfluoroheptan-1-ol | [335-99-9]-ABCR GmbH & Co KG, Karlsruhe, |
| | Germany |
| Astrazone Pink FG 200% | [3648-36-0]-DyStar Colours Deutschland GmbH, |
| | Frankfurt am Main, Germany |
| sodium bis(2-ethylhexyl) sulphosuccinate | [45297-26-5] Sigma-Aldrich Chemie |
| | GmbH, Steinheim, Germany |
| polytetrahydrofuran polyether polyol | |

### Raw Materials of Sealing Layer C

### Physically Drying Resins C1

| | |
|---|---|
| Ebecryl 1200-resin 1 | An approximately 10-tuply acryloyl-functional |
| | polyacrylate from Allnex, Brussels, Belgium. |
| Degalan M920-resin 2 | A linear thermoplastic amorphous polymethyl |
| | methacrylate with Mw = 300000 from Evonik |
| | Industries, Marl, Germany |
| APEC 1895-resin 3 | A linear thermoplastic cyclohexanone-bisphenol |
| | polycarbonate from Covestro Deutschland AG, |
| | Leverkusen, Germany. |

### Acryloyl-Functional Reactive Diluents C2

### (Reactive Diluent Abbreviated RD)

| | |
|---|---|
| Miramer M410-RD 1 | [94108-97-1] ditrimethylolpropane tetraacrylate |
| | from Miwon Specialty Chemical Co., Ltd., |
| | Gyeonggi-do, Korea. |
| Miramer M4004-RD 2 | [51728-26-8] 5-tuply ethoxylated pentaerythritol |
| | tetraacrylate from Miwon Specialty Chemical |
| | Co., Ltd., Gyeonggi-do, Korea. |
| Sartomer SR494-RD 3 | 4-tuply ethoxylated pentaerythritol tetraacrylate |
| | (PPTTA) from SARTOMER Division of CRAY |
| | VALLEY, Paris, France. |
| Ebecryl 110-RD 4 | Acrylate of ethoxylated phenol having an |
| | average degree of ethoxylation of about 2.5, |
| | from Allnex, Brussels, Belgium. |
| Desmolux XP2740- RD 5 | Flexible aliphatic allophanate-based urethane |
| | acrylate having an acrylate functionality of |
| | three, from Allnex, Brussels |

### Photoinitiators C3

| | |
|---|---|
| Irgacure 2022-initiator 1 | An 80:20 mixture of 2-hydroxy-2-methyl-1- |
| | phenyl-1-propanone and bis(2,4,6- |
| | trimethylbenzoyl)-phenylphosphine oxide |
| | from BASF, SE, Ludwigshafen, Germany. |
| Irgacure 1173-initiator 2 | 2-Hydroxy-2-methyl-1-phenyl-1-propanone |
| | from BASF, SE, Ludwigshafen, Germany. |

### Additives

| | |
|---|---|
| BYK 310-flow agent | Silicone-containing surface additive from |
| | BYK-Chemie GmbH, Wesel, Germany |
| Tinuvin 292-light stabilizer | A sterically hindered amine from BASF |
| | SE, Ludwigshafen, Germany. |
| Irganox 1135-antioxidant | A phenolic antioxidant from BASF SE, |
| | Ludwigshafen, Germany. |

### Solvents

| | |
|---|---|
| butyl acetate (BA) | Butyl acetate from Brenntag GmbH, Mülheim |
| | an der Ruhr, Germany. |
| methoxypropanol (MP) | 1-Methoxy-2-propanol from Brenntag GmbH, |
| | Mülheim an der Ruhr, Germany. |
| MPA-EEP (M/E) | A 50:50 wt % mixture of 1-methoxy-2-propanol |
| | acetate (DOWANOL ™ PMA GLYCOL ETHER |
| | ACETATE) from DOW Deutschland |
| | Anlagengesellschaft mbH, Schwalbach, |
| | Germany and ethyl 3-ethoxypropionate from |
| | Brenntag GmbH, Mülheim an der Ruhr, |
| | Germany. |

### Urethane Acrylate 1: phosphorothioyltris(oxybenzene-4,1-diylcarbamoyloxyethan-2,1-diyl) trisacrylate

A 500 mL round-bottom flask was initially charged with 0.1 g of 2,6-di-tert-butyl-4-methylphenol, 0.05 g of dibutyltin dilaurate and also 213.1 g of a 27% solution of tris(p-isocyanatophenyl) thiophosphate in ethyl acetate (Desmodur® RFE, product from Covestro DeutschlandAG, Leverkusen, Germany), followed by heating to 60° C. Subsequently, 42.4 g of 2-hydroxyethyl acrylate were added dropwise and the mixture was further maintained at 60° C. until the isocyanate content had fallen below 0.1%. This was followed by cooling and complete removal of the ethyl acetate in vacuo. The product was obtained as a partly crystalline solid.

### Urethane Acrylate 2: 2-({[3-(methylsulphanyl)phenyl]carbamoyl}oxy)ethyl prop-2-enoate

A 100 mL round-bottom flask was initially charged with 0.02 g of 2,6-di-tert-butyl-4-methylphenol, 0.01 g of dibutyltin dilaurate and 11.7 g of 3-(methylthio)phenyl isocyanate, followed by heating to 60° C. Subsequently, 8.2 g of 2-hydroxyethyl acrylate were added dropwise and the mixture was maintained at 60° C. until the isocyanate content had fallen below 0.1%. This was followed by cooling. The product was obtained as a colourless liquid.

### Polyol Component:

A 1 L flask was initially charged with 0.037 g of Desmorapid® SO, 374.8 g of ε-caprolactone and 374.8 g of a difunctional polytetrahydrofuran polyether polyol, followed by heating to 120° C. and maintenance of this temperature until the solids content (the proportion of non-volatile constituents) was 99.5 wt % or thereabove. This was followed by cooling, and the product was obtained as a waxy solid.

### Dye 1:

5.84 g of anhydrous sodium bis(2-ethylhexyl) sulphosuccinate were dissolved in 75 mL of ethyl acetate. 14.5 g of the dye Astrazone Pink FG 200%, dissolved in 50 mL of water, were added. The aqueous phase was separated off and the organic phase was extracted, three times, with 50 ml of fresh water at 50° C., the aqueous phase being separated off each time, the last one at room temperature. After the aqueous phase had been separated off, the solvent was distilled off in vacuo to obtain 8.6 g of 3H-indolium 2-[2-[4-[(2-chloroethyl) methylamino]phenyl]ethenyl]-1,3,3-trimethyl-1,4-bis(2-ethylhexyl) sulphosuccinate [153952-28-4] as a highly viscous oil.

### Fluorinated Urethane: bis(2,2,3,3,4,4,5,5,6,6,7,7-dodecafluoroheptyl) (2,2,4-trimethylhexane-1,6-diyl)biscarbamate

In a 6 L round-bottom flask, 0.50 g of dibutyltin dilaurate and 1200 g of trimethylhexamethylene diisocyanate were initially charged and heated to 80° C. This was followed by the dropwise addition of 3798 g of 1H,1H,7H-perfluoroheptan-1-ol and the mixture was maintained at 80° C. until the isocyanate content had fallen below 0.1%. This was followed by cooling. The product was obtained as a colourless oil.

### Producing Holographic Media (Photopolymer Film)

7.90 g of the polyol component described above were melted and mixed with 7.65 g of the particular urethane acrylate 2, 2.57 g of the above-described urethane acrylate 1, 5.10 g of the above-described fluorinated urethane, 0.91 g of CGI 909, 0.232 g of dye 1, 0.230 g of BYK 310, 0.128 g of Fomrez UL 28 and 3.789 g of ethyl acetate to obtain a clear solution. This was followed by the addition of 1.50 g of Desmodur® N 3900 and renewed mixing.

This solution was then applied, in a reel-to-reel coating rig, atop a 36 μm thick PET film where a blade was used to apply the product in a wet film thickness of 19 μm. The coated film was dried at a drying temperature of 85° C. for a drying period of 5 minutes and subsequently protected with a polyethylene film 40 μm in thickness. This film was subsequently packed in a light-tight package.

### Production and Characterization of Test Holograms

Test holograms were prepared as follows: the photopolymer films were, in the dark, cut to the desired size and laminated with a rubber roll onto a glass plate measuring 50 mm×70 mm (3 mm thickness).

Test holograms are made by means of a test apparatus which creates Denisyuk reflection holograms by means of green (532 nm) laser radiation. The test apparatus consists of a laser source, an optical beam-guiding system and a holder for the glass coupons. The holder for the glass coupons is mounted at an angle of 13° relative to the beam axis. The laser source generated the radiation which was guided via a specific optical path, which expands at about 5 cm, to the glass coupon, which was in optical contact with the mirror. The holographed object was a mirror about 2 cm×2 cm in size, so the wavefront of the mirror was reconstructed on reconstructing the hologram. The examples were all exposed with a green 532 nm laser (Newport Corp, Irvine, Calif., USA, cat. No. EXLSR-532-50-CDRH). A shutter was used to expose the recording film for 2 seconds in a defined manner. Subsequently, the samples were placed with the substrate side facing the lamp onto the conveyor belt of a UV source and exposed twice at a belt speed of 2.5 m/min. The UV source used was an iron-doped Hg lamp of the Fusion UV type “D Bulb” No. 558434 KR 85 with total power density of 80 W/cm². The parameters corresponded to a dose of 2×2.0 J/cm² (measured with an ILT 490 Light Bug).

This diffractive reflection is analysable in transmission by virtue of the high efficiency of the volume hologram with visible light with a VIS spectrometer (USB 2000, Ocean Optics, Dunedin, Fla., USA), and it appears in the transmission spectrum as a peak with reduced transmission. The transmission curve can be analysed to determine the quality of the hologram: the width of the peak was determined as the “full width at half maximum” (FWHM) in nanometers (nm), the depth of the peak (Tmin) was reported as 100% Tmin in percent, and the region with the lowest transmission indicates the wavelength (nm) where diffraction efficiency is highest.

Adhesively Bonding a Reflection Hologram with an Optical Clear Adhesive (OCA)

The display industry routinely employs films of optical clear adhesive (“OCA”) to bond glass layers to displays for touch functions for example. Any sealing of volume holograms of the type described above is thereby only possible at the cost of unacceptable changes in frequency. FIG. 1 thus shows the transmission spectrum of a reflection hologram recorded at 532 nm. After adhesive bonding with such an OCA (OCA-69604, UV-curing optically clear adhesive from Tesa SE, Norderstedt, Germany), FIG. 2 shows very distinct deviations in frequency, which do not permit any industrial use.

### Production of Sealing Coating Layer C on Substrate D

The formulations reported in table 1 were produced by mixing the physically drying resins C1, dissolved in the organic solvent reported, with the reactive diluent C2. Then, the photoinitiator C3 and also 0.9% of flow assistant and 0.05% each of stabilizer 1 and stabilizer 2 were admixed in the dark. The solution was blade coated onto 36 μm thick polyester film (RNK 36 from Mitsubishi Polyester Film GmbH, Wiesbaden, Germany) and dried at 60° C. for 20 minutes to obtain a film layer thickness of 3-10 μm.

TABLE 1
Compositions of sealing layer C (inventive and non-inventive examples)

| | | | | Solids | |
|---|---|---|---|---|---|
| | | | | content | |
| | | | | and | Viscosity |
| | | | | solvent | of |
| | | | | of | sealing |
| Inventive | Component | Component | Component | coating | layer |
| examples | C1 | C2 | C3 | solution | [Pa s] |
| 1 | 69.5% | 29.5% | 0.7% initiator | 30.0% | 10800 |
| | resin 1 | RD 2 | 1 and 0.3% | in BA | |
| | | | initiator 2 | | |
| 2 | 69.5% | 29.5% | 0.3% initiator | 30.0% | 10800 |
| | resin 1 | RD 2 | 1 and 0.7% | in BA | |
| | | | initiator 2 | | |
| 3 | 94.5% | 4.5% | 1% initiator 1 | 30.0% | 83800 |
| | resin 1 | RD 4 | | in BA | |
| 4 | 89.5% | 9.5% | 1% initiator 1 | 63.3% | 5000 |
| | resin 1 | RD 4 | | in BA | |
| 5 | 60% | 38% | 1% initiator 1 | 21.2% | 816400 |
| | resin 3 | RD 1 | | in M/E | |
| 6 | 40% | 58% | 1% initiator 1 | 28.8% | 16500 |
| | resin 3 | RD 1 | | in M/E | |
| 7 | 50% | 50% | 3% initiator 1 | 24.5% | 40100 |
| | resin 2 | RD 1 | | in MP | |
| 8 | 35% | 65% | 1% initiator 1 | 26.2% | 11400 |
| | resin 2 | RD 1 | | in MP | |
| 9 | 30% | 68% | 1% initiator 1 | 29.3% | 8500 |
| | resin 2 | RD 1 | | in MP | |
| 10 | 25% | 73% | 1% initiator 1 | 33.2% | 4800 |
| | resin 2 | RD 1 | | in MP | |
| 11 | 99% | — | 1% initiator 1 | 55.5% | 1534700 |
| | resin 1 | | | in BA | |
| 12 | 94% | 5% | 1% initiator 1 | 56.7% | 257300 |
| | resin 1 | RD 5 | | in BA | |
| 13 | 89% | 10% | 1% initiator 1 | 58.1% | 401200 |
| | resin 1 | RD 5 | | in BA | |
| 14 | 84% | 15% | 1% initiator 1 | 59.5% | 279900 |
| | resin 1 | RD 5 | | in BA | |
| 15 | 90% | 10% | 1% initiator 1 | 58.1% | 202400 |
| | resin 1 | RD 3 | | in BA | |
| 16 | 80% | 20% | 1% initiator 1 | 60.9% | 68000 |
| | resin 1 | RD 3 | | in BA | |
| 17 | 70% | 30% | 1% initiator 1 | 63.8% | 11000 |
| | resin 1 | RD 3 | | in BA | |
| Non- | | | | Solvent | |
| inventive | Component | Component | Component | and | Viscosity |
| examples | C1 | C2 | C3 | solids | [Pa s] |
| N1 | 10% | 88% | 1% initiator 1 | 55.4% | 200 |
| | resin 2 | RD 1 | | in MP | |
| N2 | 50% | 50% | 1% initiator 1 | 71.0% | 30 |
| | resin 1 | RD 4 | | in BA | |

Table 2, then, shows results of frequency stability measurements on test holograms involving sealing coatings 1-4 and 12-14. Holographic media containing test holograms characterized beforehand by VIS spectrometer (see the “Before bonding” column of table 2), were laminated together with the appropriate sealing lacquer to form the layered setup A-B-C-D. Curing took place within 60 seconds via UV light (layer side A oriented towards the UV lamp, belt speed 2.5 m/min, Hg lamp of the Fusion UV type “D Bulb” No. 558434 KR 85 with 80 W/cm² total power density, dosage 2 J/cm2), before layer D was removed. When the sealing lacquer C stays behind on the photopolymer layer B and is easy to separate from D, the transferability is termed “OK”. A transmission spectrum is remeasured (see the “After bonding” column of table 2). The samples were subsequently stored at 60° C. for 24 hours and remeasured (see the “After 1 d 60° C. storage” column of table 2).

TABLE 2
Test results on transferability and colour shifts or firmly adherent sealing coatings

| | | | | After 1 d | | |
|---|---|---|---|---|---|---|
| | Before | | After | 60° C. | Shift | Shift through |
| | bonding | | bonding | storage | through | 1 d 60° C. |
| | λₚₑₐₖ | | λₚₑₐₖ | λₚₑₐₖ | bonding | storage (dry) |
| Example | [nm] | Transferability | [nm] | [nm] | Δλₚₑₐₖ [nm] | Δλₚₑₐₖ [nm] |
| 1 | 529.62 | OK | 534.59 | 531.68 | −4.97 | 2.06 |
| 2 | 530.45 | OK | 534.24 | 528.18 | −3.79 | −2.27 |
| 3 | 529.62 | OK | 532.16 | 529.00 | −2.54 | −0.62 |
| 4 | 530.45 | OK | 533.89 | 531.89 | −3.44 | 1.44 |
| 12 | 529.42 | OK | 527.56 | 524.26 | 1.86 | −5.16 |
| 13 | 528.18 | OK | 527.15 | 523.44 | 1.03 | −4.74 |
| 14 | 527.77 | OK | 527.97 | 523.85 | −0.20 | −3.92 |

Table 2, then, shows that the process of the present invention proceeds with very good frequency stability on the part of the holograms. The sealing ensures good protection of the hologram and good handleability.

FIGS. 3 to 5 show the transmission spectra of the test holograms for Example 1 of table 2, which were produced from a kit-of-parts of sealing film and photopolymer film by the process of the present invention and measured before sealing (FIG. 3), after sealing (FIG. 4) and after a thermal stress period of 24 hours/60° C. (FIG. 5). The transmission spectra show the high stability of the hologram without disadvantageous colour shift (apparent from the position of the transmission minimum, which is likewise reported in table 2).

Table 3 shows further test results of thermally adherent sealing coatings. What is important for the industrial utility of sealing films formed from layer C and layer D is the film property after winding the films. To this end, a lamination film can be used to protect the sealing layer C. This is no longer successful in the non-inventive examples N1 and N2, since the uncured layer C starts to undulate as the films are being laminated and/or wound. This leads to undesirable irregular protective layer thicknesses, which is unacceptable. Similarly, an excessive tackiness (“tacky”) proves to be unsuitable to obtain a consistent lamination result. The “Rating of film property” column in table 3 reports an assessment on a scale of German school grades (“1”—very good, “2”—good, “3”—fair, “4”—satisfactory, “5”—unsatisfactory).

TABLE 3
Processability test of Examples 5-19 and of non-inventive examples N1 and N2.
Frequency stability was spectroscopically determined and reported in some examples.

| | | Rating | Assessment | | | Shift [nm] |
|---|---|---|---|---|---|---|
| | Film | of film | of film | Layer thickness of | | after 1 d 60° C. |
| Example | properties | property | property | sealing layer C | Transferability | storage |
| 5 | clear, dry | 1 | OK | 2-3 μm | OK | −1.44 |
| 6 | clear, | 2 | OK | 2-3 μm | OK | −1.44 |
| | very | | | | | |
| | slightly | | | | | |
| | tacky | | | | | |
| 7 | clear, | 2 | OK | not determined | OK | not determined |
| | very | | | | | |
| | slightly | | | | | |
| | tacky | | | | | |
| 8 | clear, | 2 | OK | 2-4 μm | OK | −6.18 |
| | very | | | | | |
| | slightly | | | | | |
| | tacky | | | | | |
| 9 | clear, | 3 | OK | 3-4 μm | OK | −6.60 |
| | slightly | | | | | |
| | tacky | | | | | |
| 10 | clear, | 3 | OK | 4-6 μm | OK | −4.12 |
| | slightly | | | | | |
| | tacky | | | | | |
| 11 | clear, dry | 1 | OK | not determined | OK | not determined |
| 12 | clear, dry | 1 | OK | not determined | OK | −5.16 |
| 13 | clear, dry | 1 | OK | not determined | OK | −4.74 |
| 14 | clear, dry | 1 | OK | not determined | OK | −3.92 |
| | gummy | | | | | |
| 15 | clear, dry | 1 | OK | not determined | OK | not determined |
| 16 | clear, | 1 | OK | not determined | OK | not determined |
| | very | | | | | |
| | slightly | | | | | |
| | tacky | | | | | |
| 17 | clear, | 2 | OK | not determined | OK | not determined |
| | slightly | | | | | |
| | tacky | | | | | |
| N1 | clear, | 5 | not OK | 5-8 μm | OK | −5.19 |
| | tacky | | | | | |
| N2 | clear, | 5 | not OK | not determined | OK | not determined |
| | slightly | | | | | |
| | tacky, | | | | | |
| | orange | | | | | |
| | peel effect | | | | | |

A comparison of tables 1, 2 and 3 reveals that the sealing coatings which are suitable have a viscosity within from 2000 Pa s to 2 million Pa s, preferably 4000 Pa s to 1.6 million Pa s, and are readily transferable to the photopolymer layer B and have good adherence.

1.-15. (canceled)

16. A kit-of-parts comprising at least one sealing layer C and an areal photopolymer B.

17. A process for producing an at least partly interconnected setup formed of at least 2 layers comprising
a) an areal photopolymer B containing a volume hologram, and
b) at least one at least partly actinically cured sealing layer C,
wherein
the photopolymer B containing a volume hologram comprises a crosslinked matrix;
the sealing layer C is less than 50 μm in thickness and has a viscosity of 2000 Pa s to 2 million Pa s, preferably 4000 Pa s to 1.6 million Pa s and comprises a physically drying resin C1, an acryloyl- or methacryloyl-functional reactive diluent C2 and a photoinitiator C3;
and the sealing layer C is laminated onto the photopolymer B and
thereafter cured with actinic radiation.

18. The kit-of-parts according to claim 16, wherein the photopolymer B is in the form of a layer, preferably on a preferably transparent thermoplastic substrate film A or on some other support.

19. The kit-of-parts according to claim 16, wherein the sealing layer C is present on a supporting film D.

20. The process according to claim 17, wherein a further sealing layer C is laminated onto the reverse side of the both-sidedly areal photopolymer B.

21. The process according to claim 17, wherein an at least partly interconnected setup formed of at least 3 layers comprising an areal photopolymer B containing a volume hologram, at least one at least partly actinically cured sealing layer C and a supporting film D is produced.

22. The process according to claim 17, wherein an at least partly interconnected setup formed of at least 4 layers comprising a layer B consisting of a photopolymer, containing a volume hologram and applied atop a substrate film A, at least one at least partly actinically cured sealing layer C and a supporting film D is produced.

23. The process according to claim 17, wherein the sealing layer C post lamination onto the photopolymer layer B is at least partly actinically cured within 60 minutes, preferably within 5 minutes, more preferably within less than 60 seconds.

24. The process according to claim 17, wherein the layer D or the layers D are at least partly delaminated post the at least partial curing of sealing layer C.

25. Use of sealing layer C to protect a photopolymer B according to claim 16.

26. Use of the kit-of-parts according to claim 16 for producing an at least partly interconnected setup formed of at least 2 layers comprising
c) an areal photopolymer B containing a volume hologram, and
d) at least one at least partly actinically cured sealing layer C,
wherein
the photopolymer B containing a volume hologram comprises a crosslinked matrix;
the sealing layer C is less than 50 μm in thickness and has a viscosity of 2000 Pa s to 2 million Pa s, preferably 4000 Pa s to 1.6 million Pa s and comprises a physically drying resin C1, an acryloyl- or methacryloyl-functional reactive diluent C2 and a photoinitiator C3;
and the sealing layer C is laminated onto the photopolymer B and thereafter cured with actinic radiation.

27. A sealed holographic medium comprising a photopolymer B according to claim 16.

28. An optical display comprising a sealed holographic medium according to claim 27.

29. An autostereoscopic and/or holographic displays, projection screens, projection lenses, displays having switchable restricted emission characteristics for privacy filters and bidirectional multiuser screens, virtual displays, head-up displays, head-mounted displays, illumination symbols, warning lamps, signalling lamps, floodlights and display panels comprising a sealed holographic medium according to claim 27.

30. A security document comprising a sealed holographic medium according to claim 27.

31. The process according to claim 17, wherein the photopolymer B is in the form of a layer, preferably on a preferably transparent thermoplastic substrate film A or on some other support.

32. The process according to claim 17, wherein the sealing layer C is present on a supporting film D.
